(19) United States
(12) Patent Application Publication
(10) Pub. No.: US 2007/0033427 A1
(43) Pub. Date: Feb. 8, 2007

(54) Power efficient cycle stealing

(75) Inventors: Anthony Correale JR., Raleigh, NC (US); Benjamin John Bowers, Cary, NC (US); Ying Liu Brown, Cary, NC (US); Veena Shankar Pureswaran, Morrisville, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 11/184,421

(22) Filed: Jul. 19, 2005

(51) Int. Cl. G06F 1/00

(52) U.S. Cl. 713/500

(57) ABSTRACT

Arrangements and methods to cycle steal and reduce power consumption in an integrated circuit are disclosed. Embodiments of the invention exploit the art of cycle stealing for increased system performance, while facilitating a more power efficient bypass mode when power conservation is desired over performance. One embodiment includes a network of integrated delay elements employing a multiplexor to transfer either a normal or a delayed clock signal to a clock splitter. Another embodiment includes a network of delay elements, configured to enable or disable power conservation. A further embodiment integrates a configurable delay circuit into a clock splitter arrangement.

### FIELD OF INVENTION

The present invention is in the field of integrated circuits. More particularly, the present invention relates to arrangements and methods for increasing speed by the use of cycle stealing techniques or reducing power consumption when not cycle stealing.

### BACKGROUND

Our society depends heavily upon integrated circuits, including processors, in our everyday activities. Processors control devices in our homes, in our business offices and manufacturing facilities, in our automobiles, in airplanes and trains, and even in outer space aboard space shuttles and geosynchronous satellites. One finds processors, including microprocessors, in such devices as desktop and laptop computers, conventional and mobile telephones, televisions, and radios.

Since the creation of processors, electronic designers have increasingly utilized them as they recognized their versatility. Today people are continually finding new applications that benefit from processors and embedded controllers. Additionally, applications already employing processors are continually being upgraded with newer, faster, and improved processors.

Processors have undergone tremendous change in their design. New applications demand improved processor performance, such as increased speed and additional features. As the need for improved performance has grown, so too has the number of transistors in processors. Many processors today contain millions of transistors. Increasing the number of transistors and the speeds of processors generally increases electrical power consumption. In a large number of applications, this increased power consumption presents problems.

For one example, consider the use of feature-rich and high performance processors in cellular telephones. These high performance processors tend to demand more power than the previous processors. However, these increases in power consumption result in shorter battery lives. Similarly, there are many other applications employing processors that face similar dilemmas. Consider as a second example the common dilemma that many applications face, the problem of heat dissipation. While these applications could benefit from using high performance processors, the applications may have environment or packaging limitations that are not conducive for efficient heat dissipation. Inadequate thermal solutions lead to overheating and loss of life.

Many of these applications have both a need for improved processor performance with a concurrent need for decreased power consumption. In other words, these applications could employ higher performance processors if the power consumption were somehow reduced. Unfortunately, both of these objectives tend to be mutually exclusive. As stated above, the higher performance processors tend to gain the high performance features by increasing the number of transistors and other integrated circuit elements. Generally, when the number of integrated circuit elements increase, so too does the quantity of power consumed. What would really be beneficial is a technique that would both improve processor performance and yet allow for decreased power consumption whenever possible. A method of approach to solving this problem is by looking at how the additional transistors and other integrated circuit elements, employed by circuits such as high performance processors, are implemented to create the enhanced performance.

Quite often, integrated circuit and processor designers increase performance of integrated circuits by employing a technique known as cycle stealing. This practice involves “stealing” a portion of time available for solving the logic in one circuit, which does not have a critical timing problem, and using this “stolen” portion of time to solve logic in second circuit. In many cases, this second circuit may be a critical circuit that constitutes a bottleneck and limits the maximum frequency of the entire system or overall design.

In brief, cycle stealing involves skewing or time shifting associated arrival times of clocks feeding respective latches. To shift the arrival times of the clocks, the clock signals must be delayed or skewed. Adding delay circuits, buffers, or other similar delay devices into the clock paths creates these delays. Unfortunately, these additional circuit elements usually employ more transistors, which in turn consume more power. Consequently when applications require integrated circuits that consume less energy, designers today make trade-off design decisions between power and performance. In other words, designers are forced to implement fewer circuit elements to conserve power, which tends to decrease the system performance.

There is a critical reason why designers today must make trade-off design decisions between power and performance when employing the technique of cycle stealing. Cycle stealing circuits, in the manner in which they are implemented today, continually consume power. That is to say, today designers arrange the cycle stealing circuits so that these circuits constantly draw power on each clock cycle. Additionally, in the art of design today, designers implement the cycle stealing circuits in a fixed and inflexible manner, where the cycle stealing circuits cannot be disabled. What are needed are ways to steal cycles upon demand, with a way to turn off or bypass these cycle stealing circuits and reduce power consumption when desired.

### SUMMARY OF THE INVENTION

This invention addresses the problem of decreasing power consumption while enhancing integrated circuit performance by using circuits and methods for power efficient cycle stealing. One embodiment provides a general circuit that selects between a normal clock signal and a delayed clock signal. The general circuit contemplates a delay circuit which adds a delay to a normal clock signal and produces a delayed clock signal; and a multiplexing circuit coupled to the delay circuit which selects between the normal clock signal and the delayed clock signal based on a multiplexor control signal, such that selecting the delayed clock signal delays latching of an output for a first logic path to an input of a second logic path to increase a first quantity of time available for evaluation in the first logic path and thereby reducing a second quantity of time available for evaluation in the second logic path. The delay enable signal and the multiplexor control signal may be logically the same.

Another embodiment provides a circuit for skewing a normal clock signal, to be employed for cycle stealing. The circuit contemplates delaying a clock signal applied to the input of the delay circuit by propagating the clock signal through a network of transistors, arranged in delay stages. The circuit includes transistors in one of the delay stages that allow an external signal to disable the delay circuit. Additionally, the circuit includes a transistor that drives the output of a disabled delay stage to a predetermined voltage level. Driving the output of the disabled delay stage in this manner eliminates downstream leakage due to tri-stating of the disabled delay stage.

A further embodiment provides a clock splitting circuit for cycle stealing, with a means for inserting a delay immediately after the first stage gating function. The circuit contemplates an input circuit for receiving a normal clock signal and generating a gated clock signal based upon the normal clock signal; a delay circuit coupled to the input circuit to add a time delay to the gated clock signal; a clock splitting circuit coupled to the delay circuit to generate more than one clock signals based upon the gated clock signal; and a clock splitter output circuit coupled to the clock splitting circuit to drive more than one combinational logic circuits.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system for selecting clock stealing logic or power conserving logic;

FIG. 2 depicts an embodiment of a circuit including a clock signal, a delay circuit, a multiplexor, a clock splitter, and latch circuits;

FIG. 3 depicts an embodiment of a delay circuit including an input, an output, enable signals, a network of minimum channel length N-channel and P-channel field-effect transistors, and a disabling transistor;

FIG. 4a depicts an embodiment of a clock splitter circuit including a clock gating stage, a cycle stealing delay arrangement, a clock splitting stage, a spatial adjustment stage, and an output stage;

FIG. 4b depicts a delay circuit for creating a delayed clock signal from a normal clock signal;

FIG. 4c depicts a multiplexor coupled with a delay circuit for transmitting either a normal clock signal or a delayed clock signal;

FIG. 4d depicts a multiplexor coupled with more than one delay circuit for transmitting either a normal clock signal or one of multiple delayed clock signals;

FIG. 5 depicts an example flow chart to either steal cycles or conserve power in an integrated circuit.

FIG. 6 depicts an example flow chart for power efficient cycle stealing with a clock splitter circuit.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, arrangements and methods to enhance speed and reduce power consumption in integrated circuits are contemplated. These embodiments of the invention demonstrate an approach to exploit the art of cycle stealing for increased system performance, while allowing for a more power efficient bypass mode when power efficiency is more important than performance. Some embodiments include a network, or circuit, of integrated delay elements that creates independent paths for a clock signal. Some embodiments provide two modes of operation, a cycle stealing mode and a power conservation mode. Depending on the mode, a multiplexor may transmit either a normal clock signal or a delayed clock signal to a clock splitter. While in the power conservation mode, cycle stealing may be disabled to save power and the multiplexor may transmit the normal, unmodified, clock signal to the clock splitter. While in the cycle stealing mode, the delay circuit may be enabled to skew the clock signal. The multiplexor may then transmit the clock signal to the clock splitter through the multiplexor, to increase the overall system performance.

The embodiments generally provide two modes of operation. In the first mode, when a delay circuit is enabled, an arrangement of transistors adds a delay to a clock signal input. In the second mode, the delay circuit is disabled to advantageously reduce power consumption when cycle stealing is not utilized. Additionally, when the delay circuit is disabled, the arrangement of transistors forces the intermediate and output nodes to a known state and prevents tri-stating. Disabling the delay circuit in this manner attenuates ground currents, current loops, leakage power, and extraneous power consumption in general. One embodiment employs a series stack of four short channel length transistors in the input stage of the delay circuit to emulate the series conductance of longer channel devices. Two of the four transistors are turned off to disable the delay circuit.

A further embodiment employs a cycle stealing circuit coupled with a multiple-phase clock splitter. The cycle stealing unit may be coupled at a strategically chosen stage in a clock splitter to adjust cycle stealing time. While the cycle stealing unit may be coupled at numerous points within the clock splitter, one embodiment may couple the cycle stealing unit after clock gating but before clock splitting and spatial adjustment stages to advantageously employ cycle stealing with a single delay circuit that is turned off while the clock gating stage blocks the clock signal.

While specific embodiments will be described below with reference to particular circuit configurations of a multiplexor, delay-generating circuitry, and other components, those of ordinary skill in the art will realize that embodiments of the present invention may be implemented in other circuit configurations. For example, while the use of short channel length transistors is discussed throughout the disclosure for the delay circuit, long-channel devices and other buffer elements are contemplated.

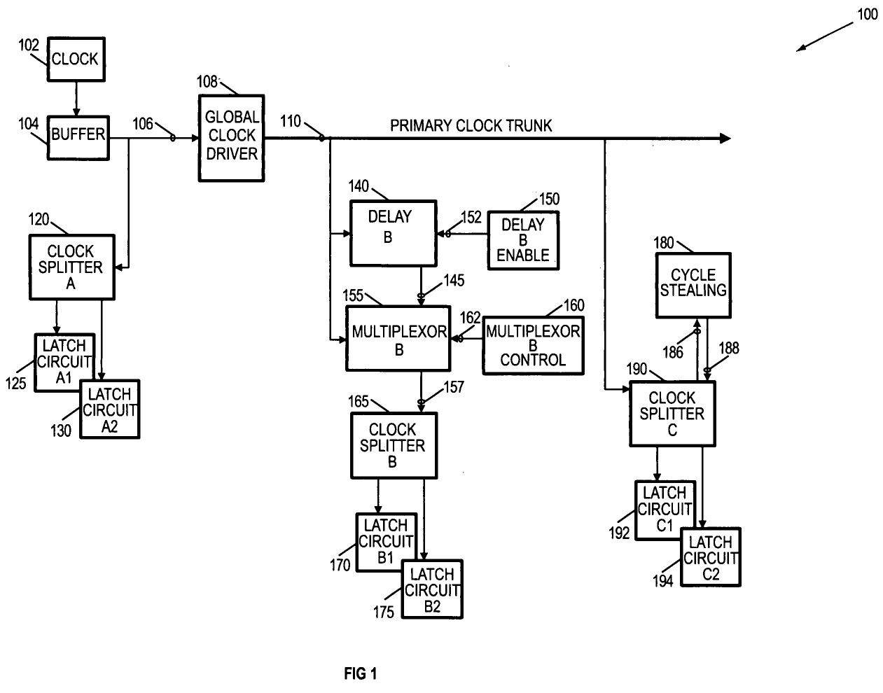

Turning now to the drawings, FIG. 1 depicts an embodiment of a system 100 in which the technique of power efficient cycle stealing may be employed. The system 100 shows a general clock network driving several clock splitting systems. More specifically, system 100 depicts a clock signal circuit 102 coupled to a global clock driver 108 through a buffer network 104. The global clock driver 108 drives a primary clock trunk 110, which is a typical design used in processor systems to trigger latching circuits.

Clock splitter A 120 is depicted as a typical clock splitter, employing no means for power efficient cycle stealing. Clock splitter A 120 receives a clock signal 106 after the clock buffer network 104 and generates clocking signals for latching circuits, here latching circuit A1 125 and latching circuit A2 130. Depending on the system needs, a system may employ many or none of these typical clock splitters, which have no means for power efficient cycle stealing. When power efficient cycle stealing is desired or needed, though, one may use the technique employed for clock splitter B 165.

Similar to clock splitter A 120, clock splitter B 165 may generate clocking signals for latching two circuits, latching circuit B1 170 and latching circuit B2 175. However, clock splitter B 165 may not directly receive a clocking signal from the primary clock trunk 110. Instead, clock splitter B 165 may be clocked from a multiplexor B circuit 155 via a multiplexor B output 157. Multiplexor B circuit 155 may pass one of several different clock signals to multiplexor B output 157 depending on the state of a multiplexor B control circuit 160. In the system shown in FIG. 1, multiplexor B circuit 155 may either pass the clock signal from the primary clock trunk 110 or pass a delayed clock signal 145 from delay B circuit 140, based on an output signal 162 of the multiplexor B control circuit 160.

When the multiplexor B control circuit 160 is in one mode, which may be referred to as a normal mode, multiplexor B circuit 155 may ignore the delay B circuit output 145 and pass the clock signal from the primary clock trunk 110 to clock splitter B 165. While in this normal mode, power may be conserved in delay B circuit 140 by turning it off using a delay B enable circuit 150. Delay B enable circuit 150 may disable delay B circuit 140 by turning off a delay B enable signal 152. Multiplexor B control circuit 160 and delay B enable circuit 150 may be one circuit, thereby controlling both the multiplexor B circuit 155 and delay B circuit 140 concurrently.

Alternatively, when the multiplexor B control circuit 160 is in another mode, which may be referred to as a cycle stealing mode, multiplexor B circuit 155 may ignore the clock signal from the primary clock trunk 110 and instead couple the delay B circuit output 145 to clock splitter B 165. While in this cycle stealing mode, turning on the delay B enable signal 152 enables delay B circuit 140.

For the sake of clarity and understanding, FIG. 1 depicts a relatively simple system. However, many variations of system 100 are anticipated and will benefit greatly from the power efficient cycle stealing methods detailed in the embodiments of this invention. For example, note that the clock signal used for the delay B circuit 140 and the multiplexor B circuit 155 is intentionally depicted as a clock signal from the primary clock trunk 110 after a global clock driver 108. However, one skilled in the art will realize that a clock signal may be taken from many points in the system and still be confined within the boundaries of this invention.

An embodiment of system 100 may include a power efficient cycle stealing circuit coupled to a clock signal before the global clock driver at an output 106 of the clock buffer 104. This may be necessary when the delay time needed for cycle stealing is more than the delay time associated with the global clock driver 108. Alternatively, these power efficient cycle stealing elements may be inserted at multiple points along the clock tree network. The particular system requirements will dictate where a clock signal for the delay B circuit 140 and the multiplexor B circuit 155 originates.

Similar to selecting alternate origins for the clock signal, designers may also employ the benefits of this invention by selecting alternate locations for the delay and multiplexor circuits. As shown in FIG. 1, one embodiment of this invention may implement a cycle stealing circuit 180 integrally with a clock splitter C 190. This arrangement should be contrasted with the delay B circuit 140 and multiplexor circuit 155, which are implemented before clock splitter B 165 and directly receive input clock signal 110.

A second clock signal 186, derived from a point within clock splitter C 190, may be transmitted to the cycle stealing circuit 180. Cycle stealing circuit 180 may add a delay to the secondary clock signal 186, resulting in delayed clock signal 188. Different embodiments may incorporate cycle stealing circuit 180 at numerous points within the clock splitter C 190. Alternatively, combinations of cycle stealing circuits may be implemented at the outputs of clock splitter C 190, before the output latch circuits C1 and C2, 192 and 194 respectively.

Another embodiment of system 100 may include multiple delay circuits similar to delay B circuit 140, coupled to multiplexor B circuit 155. One might employ such an arrangement when latch circuits B1 170 and B2 175 need different amounts of cycle stealing time. In this arrangement, multiplexor B circuit 155 may pass one of the several different delay B circuit outputs 145 to the clock splitter B 165, based the state of multiplexor B control circuit 160. In this scenario, one or more delay B circuits 140 may be enabled and disabled using one or more delay B enable circuits 150.

System 100 shows clock splitter A 120, clock splitter B 165, and clock splitter C 190 as dual clock splitters. Another embodiment of the invention may contain clock splitters that latch a number of different latch circuits. For example, in addition to latch circuit B1 170 and latch circuit B2 175, there may be other latch circuits B3, B4, and so on. Employing a clock splitter that controls many latch circuits may be necessary in more complex and advanced circuits.

In different embodiments, the amount of the delay created by delay B circuit 140 may differ in magnitude, with the delay circuits designed to satisfy the necessary system timing adjustments for cycle stealing. In other words, the delay circuit may employ a number of staged elements as necessary to generate the required delay time. Generally, implementing more stages increases the amount of delay time. With embodiments that contain multiple delay B circuits 140, each delay circuit arrangement and delay time may be different. Additionally, the delay time generated by delay B circuit 140 may be defined to compensate for the delay associated with multiplexor B circuit 155.

In some embodiments, hardware or circuit elements may dynamically generate delay B enable signal 152 and multiplexor B control signal 162. These circuit elements may include the hardware for the system 100 basic input/output system (BIOS), determined during system booting. In other embodiments, the operating system may control the hardware or circuit elements that generate the delay B enable signal 152 and multiplexor B control signal 162. In yet other embodiments, the delay B enable signal 152 and multiplexor B control signal 162 may be controlled by switches or even firmware, which may be preconfigured at the system 100 factory.

Furthermore, one may note that delay B enable signal 152 and multiplexor B control signal 162 are depicted as separate and distinct signals. However, as conditions and system requirements permit, both signals may originate from the same source and therefore be logically equivalent. As a corollary, in other embodiments employing multiple delay B circuits 140, the delay B enable signals 152 and the multiplexor B control signals 162 may have different origins. That is to say, the delay B enable signal 152 for one delay B circuit 140 will originate from a different source than a second delay B enable signal 152 for a second delay B circuit 140. This same idea of independent origins may hold true for different multiplexor B control signals 160.

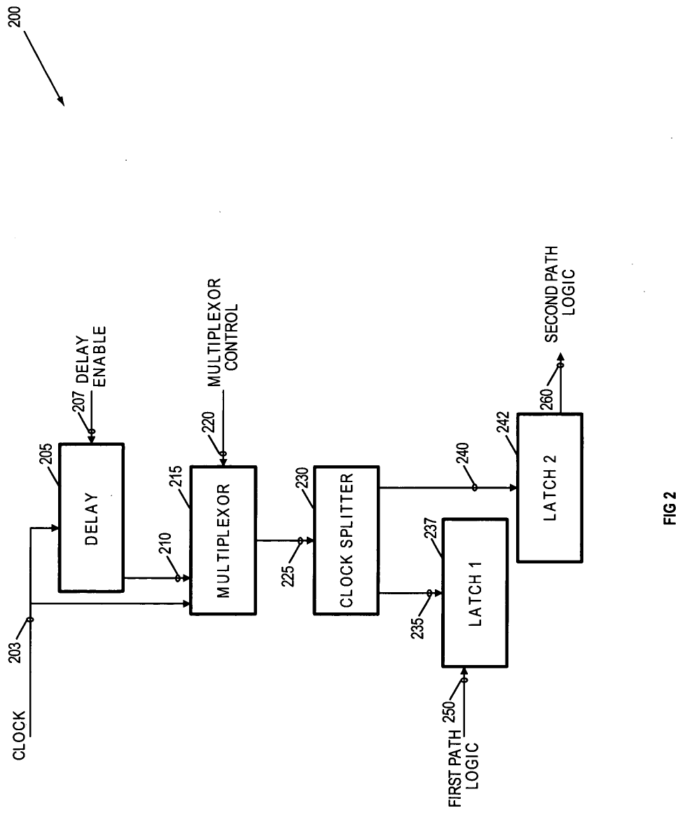

FIG. 2 depicts an embodiment of a circuit 200 for power efficient cycle stealing. The circuit 200 has two modes of operation: a normal mode and a cycle stealing mode. When in the normal mode, a clock signal propagates through the system unaltered. When in the cycle stealing mode, on the other hand, the clock signal propagates through a delay circuit, or network. A multiplexor transfers either the normal or delayed clock signal from the system. In particular, a multiplexor 215 selects between a normal clock signal 203 and a skewed clock signal 210, depending on which mode of operation is desired.

### NORMAL MODE

In the normal mode, the multiplexor control input 220 may be logically low and multiplexor 215 may transfer a normal clock signal 203 to the multiplexor output 225. The multiplexor output 225 may be coupled to a clock splitter 230. The first phase clock splitter output 235 and second phase clock splitter output 240 may enable latch circuits 237 and 242, respectively.

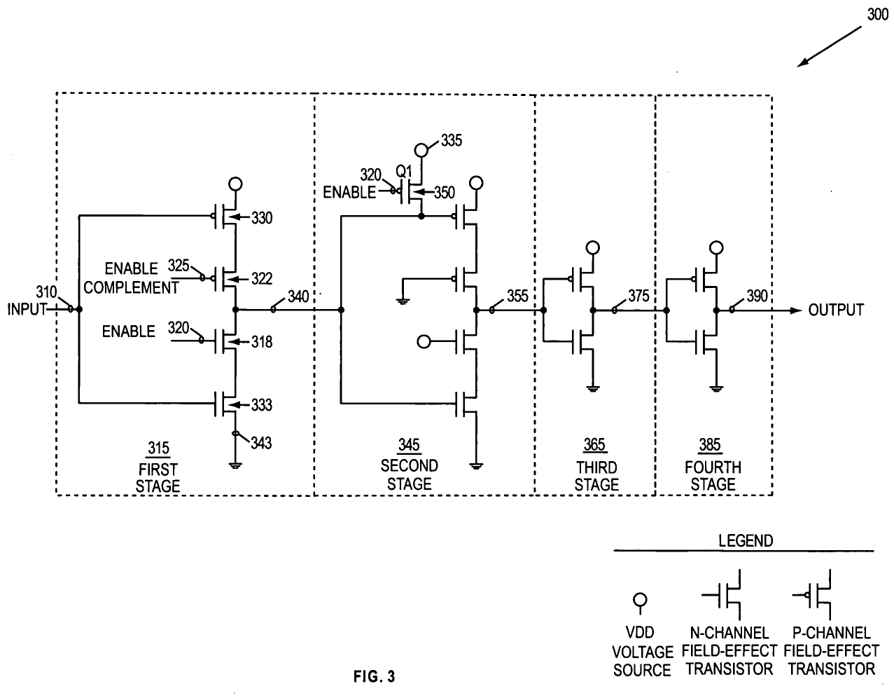

While in the normal mode, power may be saved in a delay circuit 205 by deactivating the delay enable input 207. In general, simply turning off a circuit in this manner decreases the dynamic power consumption caused by the charging and discharging of capacitive loads within that circuit. For example, one may want to conserve power when the system operation or system frequencies do not require cycle stealing. A designer may employ several methods to reduce power in the delay circuit 205; another method will be discussed momentarily and is noted in FIG. 3.

### CYCLE STEALING MODE

A second mode of operation may be referred to as the cycle stealing mode. In this mode, the multiplexor control input 220 and the delay enable input 207 may activate both multiplexor 215 and delay circuit 205, respectively. When enabled, the delay circuit 205 skews clock signal 203 by adding a delay, creating a delayed clock signal 210, and may transfer the delayed clock signal 210 to multiplexor 215. When multiplexor control input 220 is logically high, multiplexor 215 transfers the delayed or skewed clock signal 210 to multiplexor output 225. Multiplexor output 225 may be coupled to a clock splitter 230. A first phase clock splitter output 235 and a second phase clock splitter output 240 may enable latch circuits 237 and 242, respectively. Additionally, in this cycle stealing mode, latch circuits 237 and 242 latch after a delay in time created by introduction of the delay circuit 205.

Latch circuit 237 and latch circuit 242 may be located in a string of path logic, including a first path logic 250 and a second path logic 260. When the system is in the normal mode, latch circuit 237 and latch circuit 242 are operated using the normal clock signal 203, and no cycle time is removed from the time available for the second path logic 260. However, one may conserve power by disabling delay network 205 via delay enable input 207.

On the other hand, when the system is in the cycle stealing mode, latch circuit 237 and latch circuit 243 operate using skewed clock signal 210. Cycle time is removed from the time available for the second path logic 260, in an amount determined by the delay network 205, and effectively transferred to the time available for the first path logic 250.

FIG. 3 depicts a detailed embodiment of a delay circuit 300 with an integrated enable feature, such as delay B 140 of FIG. 1. Many delay circuits employ a series stack of minimum channel length transistors rather than long-channel devices. These series devices are used to emulate the series conductance of longer channel devices without the model-to-hardware correlation issues. Delay circuit 300 comprises a network of N-channel field-effect transistors (N-fets) and P-channel field effect transistors (P-fets), and is merely one embodiment of a delay circuit that may be employed in the power efficient cycle stealing system 300.

When properly enabled, delay circuit 300 will propagate an unskewed clock signal applied to the delay circuit input 310 through four stages of delay; a first delay stage 315, a second delay stage 345, a third delay stage 365, and a fourth delay stage 385. While this network employs four stages, the number of stages of delay in a delay circuit may differ depending on the amount of delay time desired. The number of stages, whether odd or even, also determines whether the output is inverted or not. The resulting skewed clock signal product of delay circuit 300 will emanate from a delay circuit output 390.

To implement an enable and disable feature, the gates of these same field-effect transistors may be coupled to either an enable or an enable complement signal. In this particular embodiment, the delay circuit 300 has an enable signal 320 coupled to an N-fet 318 and an enable complement signal 325 coupled to a P-fet 322 in the first delay stage 315. When one desires to disable the circuit 300, transitioning enable signal 320 to a logical low voltage (low) will effectively turn off N-fet 318 due to reverse-bias. Similarly, when the enable signal 320 transitions low, the enable complement signal 325 transitions to a logical high voltage (high) and turns off P-fet 322. Employing enable and enable complement signals in this manner prevent a cycling clock signal applied to the delay circuit input 310 from propagating through the second delay stage via the second delay stage input coupling 340. Stated more precisely, as delay circuit input 310 transitions from high to low, and vice-versa, turning off the first stage transistors 322 and 318 in the manner mentioned above prevents transitioning signals transmitted from first stage P-fet transistor 330 and first stage N-fet 333 from reaching the second delay stage 345 via the second delay stage input coupling 340. Likewise, turning off the first stage in this manner prevents a cycling clock signal applied to the delay circuit input 310 from propagating through the third delay stage 365 and fourth delay stage 385.

Delay circuit 300 may include a pull-down N-fet or pull-up P-fet transistor, such as Q1 pull-up P-fet 350. Employing Q1 pull-up P-fet 350 in this manner attenuates downstream leakage due to tri-stating of the first delay stage 315. When the enable signal 320 applied to the gate of Q1 pull-up P-fet 350 goes low, as in the case when power conservation is desired, the potential voltage of the second delay stage input 340 will be increased to substantially near supply voltage Vdd 335. When the second delay stage input 340 is held logically high in this manner, the third delay stage input 355 will be held low, the fourth delay stage input 375 will be held high, and the delay circuit output line 390 will be held low. Confining subsequent stages in this manner attenuates downstream leakage.

While delay circuit 300 employs Q1 pull-up P-fet 350 to attenuate downstream leakage due to tri-stating of the output of the first stage, a pull-down N-fet may be employed as an alternative. When an enable complement signal 325 applied to the gate of a pull-down N-fet goes high, as in the case when power conservation is desired, the potential voltage of the second delay stage input 340 will decrease to near ground 343 potential. When the second delay stage input 340 is held logically low in this manner, the third delay stage input 355 will be held high, the fourth delay stage input 375 will be held low, and the delay circuit output line 390 will be held high.

While Q1 pull-up P-fet 350 may be implemented in the second stage, a pull-up P-fet or pull-down N-fet may be implemented in other stages with comparable effect. Furthermore, while the enable and disabling functions performed by N-fet 318 and P-fet 322 may be located in the first delay stage 315, these enabling and disabling functions may be employed in other stages as well.

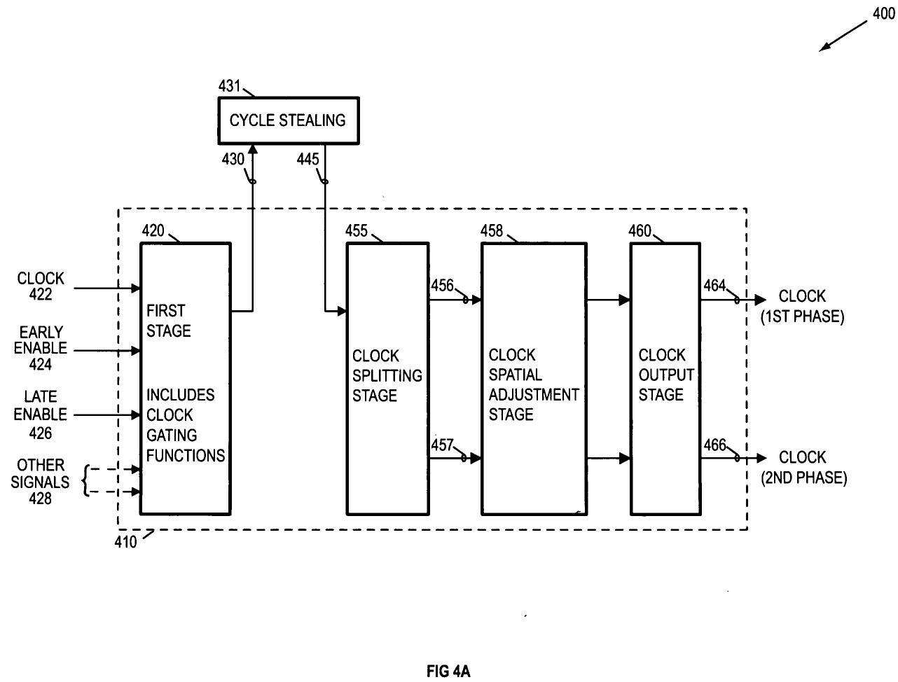

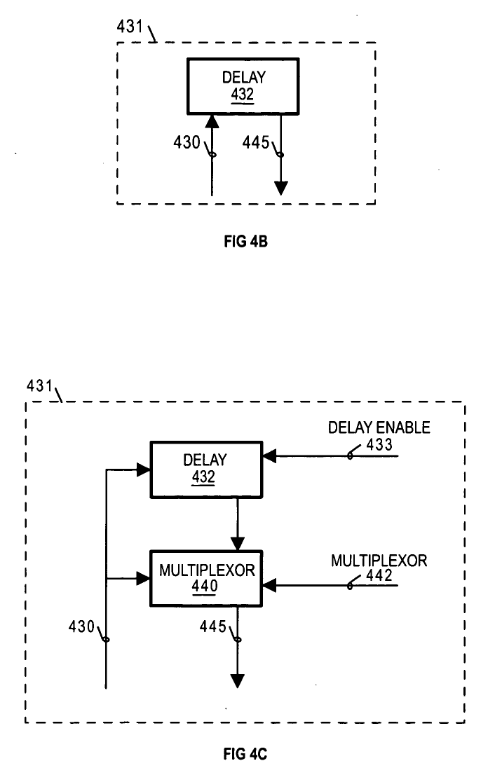

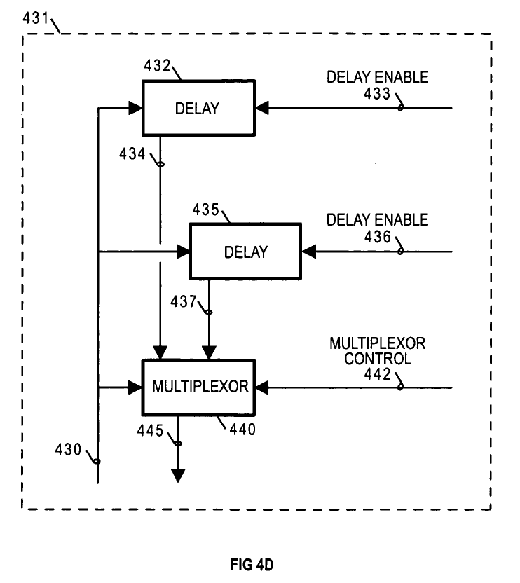

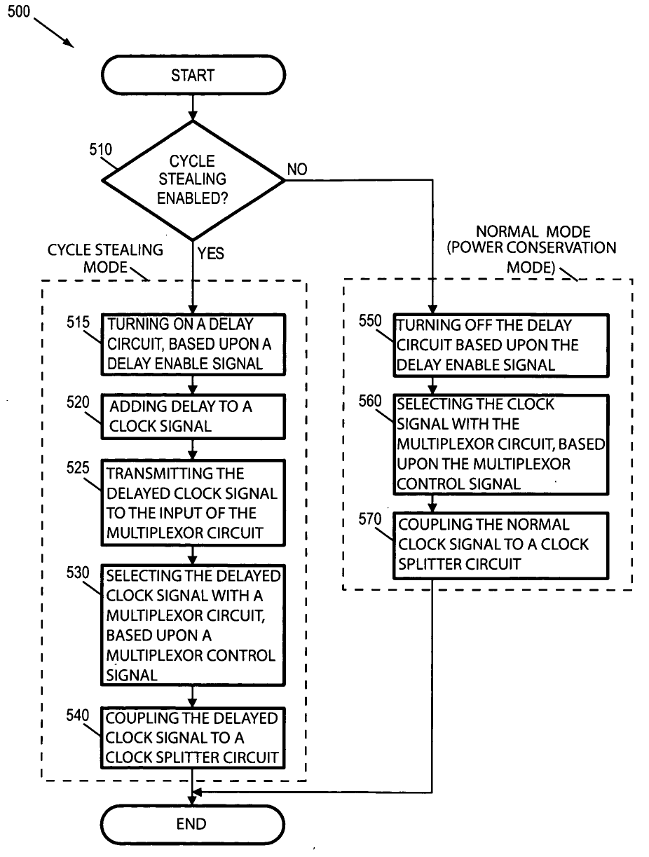

Referring now to FIG. 4a, there is shown an example clock splitter circuit 400 which may delay clock signals for power efficient cycle stealing. In the present embodiment, clock splitter 400 comprises five stages. The first stage 420 may provide clock gating functions based on a clock input signal 422, an early enable signal 424, a late enable signal 426, and other control and test signals 428. An output 430 of the clock splitter first stage 420 may be coupled with a cycle stealing stage 431. Implementation of the cycle stealing stage 431 after a clock splitter first stage 420 but before a clock splitting stage 455 has efficiency benefits, discussed later.

Because the amount of delay needed may not be known until the final timing requirements are known, integrating a delay directly into the splitter may be difficult. However, one embodiment may provide a set of terminals to capture the output 430 of the clock splitter first stage 420 and a clock splitting stage input 445. Implementing the cycle stealing stage 431 in this manner may allow any amount of delay, including no amount of delay, to be added to the clock signal for the clock splitting stage input 445. The resulting clock splitting signals 456 and 457 from the clock splitting stage 455 may be overlapped, coincident, and even separated in a spatial adjustment stage 458. The output stage 460 may then drive clock splitter 410 output signals, first phase clock signal 464 and second phase clock signal 466.

As one example of the cycle stealing second stage, FIG. 4b shows that delay circuit 432 may comprise cycle stealing stage 431. Similar to the delay network depicted in FIG. 3, delay circuit 432 may comprise a network of short channel transistors that add a delay to the output signal 430 from the clock splitter first stage 420 before transmitting a delayed clock signal to the clock splitting stage input 445. Adding a delay in the clock splitter in this manner may conserve power by reducing the number of delay circuits necessary for cycle stealing, which would be the case for adding multiple delay circuits to the first and second phase clock outputs, 464 and 466 respectively, of clock splitter 410 in FIG. 4a.

In another example embodiment, FIG. 4c shows that cycle stealing delay circuit 432 coupled with a multiplexor 440 may comprise the cycle stealing stage 431. This embodiment may bypass the delay circuit 432 and pass the clock splitter first stage output signal 430 to the clock splitting stage input 445, based on the state of a multiplexor control signal 442. When delay circuit 432 is bypassed in this manner, turning off a delay enable signal 433 may disable the delay circuit to conserve power. When cycle stealing is desired, though, the delay enable signal 433 may enable the delay circuit 432, wherein the delay circuit 432 may add a delay to the first stage output signal 430. Changing the state of the multiplexor control signal 442 may then switch multiplexor 440, thereby transmitting the delayed clock signal to the clock splitting stage input 445.

Integrating a cycle stealing stage 431 after the clock splitter first stage 420 may also be beneficial because one can take advantage of the early enable signal 424, late enable signal 426, and other signals 428 for controlling the delay circuit 432 and multiplexor 440. Because the early enable signal 424 and late enable signal 426 may deactivate the clock splitter 410 from propagating the clock input signal 422 to the 430 output, no downstream circuit, including cycle stealing circuit 431, will dissipate any switching power. In this manner, cycle stealing may be activated while still having the most power efficient method. A designer may implement the cycle stealing stage 431 before the clock splitter first stage 420 or after the clock splitting stage 455, but doing so may add more complexity and require more delay elements. For example, implementing a cycle stealing stage 431 before the clock splitter first stage 420 may require additional circuit elements to properly delay the clock signal 422, the early enable signal 424, the late enable signal 426, and the other control signals 428. Similarly, implementing a cycle stealing stage 431 immediately after the clock splitting stage 455 may require additional circuit elements to properly delay multiple clock signals, such as clock splitting stage outputs 456 and 457.

Another embodiment of a cycle stealing clock splitter 400 may incorporate multiple delay circuits. Such an embodiment may have two delay circuits, such as delay circuit 432 and delay circuit 435, shown in FIG. 4d. These two delay circuits, 432 and 435, may also have multiple enable signals 433 and 436. As also shown in FIG. 4d, a multiplexor 440 may select from the delay circuit 432 delayed clock signal 434 and delay circuit 435 delayed clock signal 437. The benefit of having multiple delay circuits may be the fact that each delayed clock signal may have a different amount of delay, configured based on the overall system needs. Additionally, either delay circuit 432 or delay circuit 435 may be disabled via delay enable signals, 433 and 436, respectively, to conserve power.

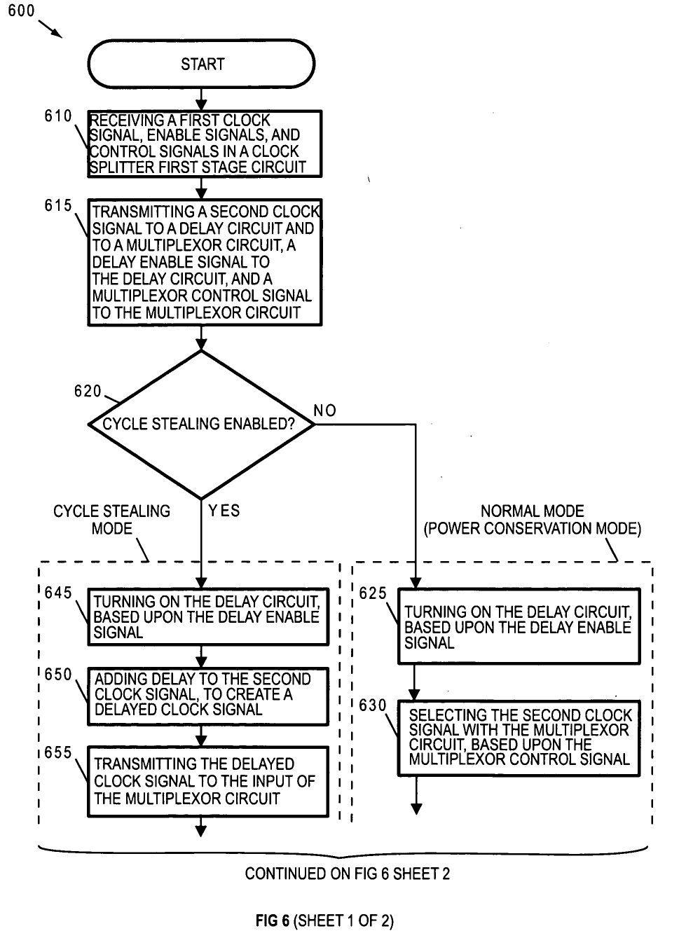

Referring now to FIG. 5, an example flow chart 500 shows a technique to either steal cycles in an integrated circuit when high performance is advantageous or to turn off cycle stealing and conserve power when cycle stealing is not wanted, similar to cycle stealing and power conserving circuit 200 depicted in FIG. 2. External system factors, such as an operating system parameter based on low remaining battery or a hardware switch, determine if cycle stealing should be employed (element 510). The system is placed into one of two modes based on the system cycle stealing requirements. When power conservation is deemed more desirable than higher performance, the system may be placed in the normal mode, or power conservation mode. Otherwise, the system is placed in the cycle stealing mode.

### NORMAL MODE

When in the normal mode, the delay enable signal will disable the delay circuit (element 550). Disabling the delay circuit may reduce power consumption by attenuating ground current, eliminating current loops, and generally decreasing the dynamic power consumption caused by the charging and discharging of capacitive loads within that circuit. The multiplexor control signal may then switch the multiplexor circuit, selecting the normal or unskewed clock signal input (element 560). When this happens, the multiplexor circuit ignores any output signals from the delay circuit and couples the unskewed clock signal to the clock splitting circuit (element 570). After the multiplexor couples the unskewed clock signal to the clock splitting circuit, the clock splitting circuit may process the clock signal in a normal manner, such as for latching path logic circuits.

### CYCLE STEALING MODE

When the system is in the cycle stealing mode, the delay enable signal may enable the delay circuit (element 515). Once enabled, the delay circuit may then receive the clock signal and add a delay time (element 520), the amount of delay time based on the configuration or design of the delay circuit. After the delay circuit adds a delay time to the clock signal, the delayed or skewed clock signal is then transmitted to a delayed clock input of the multiplexor circuit (element 525).

Upon receiving the delayed clock signal at the multiplexor, the multiplexor control signal may switch the multiplexor circuit, selecting the delayed clock signal input (element 530). After selecting the skewed clock signal, the multiplexor then couples the skewed clock signal to the clock splitting circuit (element 540). After the multiplexor couples the delayed clock signal to the clock splitting circuit, the clock splitting circuit may then use the clock signal for latching path logic circuits.

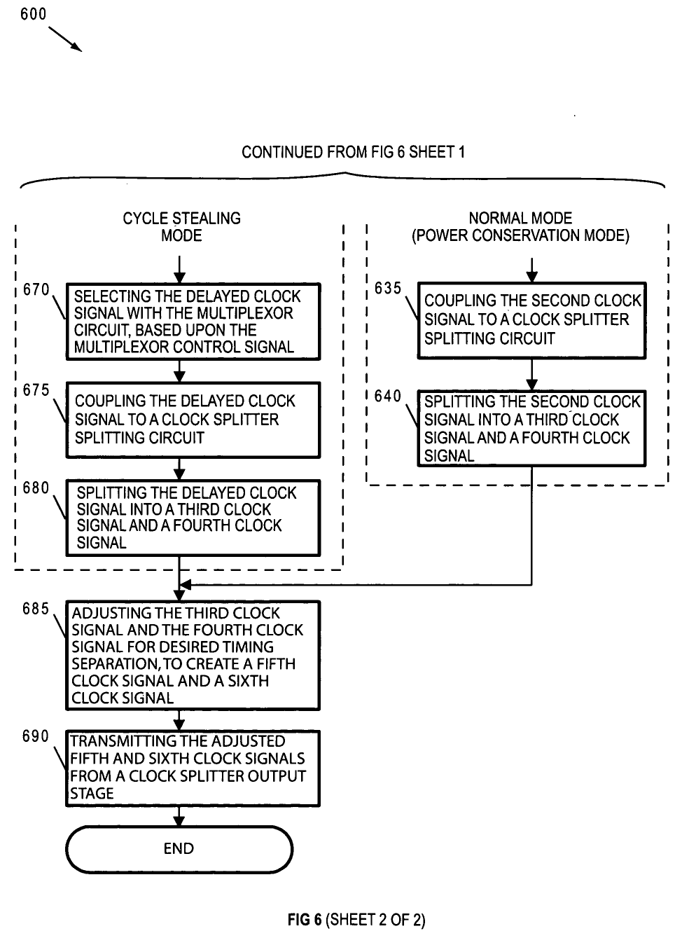

Concluding our detailed description of embodiments, we turn now to FIG. 6 which shows an example flowchart outlining a method for efficient cycle stealing within a clock splitter. The method discloses a technique to either steal cycles in a clock circuit when high performance is desired or turn off cycle stealing circuit elements and conserve power when cycle stealing is not desired. Again, this embodiment is similar to cycle stealing and power conserving circuit 200 depicted in FIG. 2, but integrally coupled to a clock splitter.

Flow chart 600 begins with receiving a first clock signal, enable signals, and control signals at a clock splitter first stage (element 610). The first stage provides gating functions for these clock, enable, and control signals. After being received at the clock splitter first stage, the first clock signal may be altered in the clock splitter first stage, based on the enable and control signals, producing a second clock signal.

This second clock signal may then be transmitted to a delay circuit and a multiplexor circuit (element 615). Additionally, a delay enable signal will be transmitted to the delay circuit and a multiplexor control signal to the multiplexor circuit (element 615). The delay enable signal will dictate whether the delay circuit is enabled for cycle stealing, or disabled to conserve power in the delay circuit. In conjunction with the delay enable signal, the multiplexor control signal will force the multiplexor to couple either the second clock signal or the delayed clock signal to the splitting stage of the clock splitter. Which signal the multiplexor couples to the splitting stage depends on the mode of the cycle stealing clock splitter.

Again factors external to the clock splitter system may determine if cycle stealing should be employed (element 620). Good examples of such factors are an operating system parameter based on low remaining battery power or a hardware switch. Depending on the desire to either conserve power or steal cycles, the system is placed into one of two modes based on the system cycle stealing requirements. When system performance is deemed more desirable than power conservation, the system may be placed in the cycle stealing mode. Otherwise, the system is placed in the normal mode.

### NORMAL MODE

When in the normal mode, the delay enable signal will disable the delay circuit (element 625). Disabling the delay circuit may reduce power consumption by attenuating ground current, eliminating current loops, and generally decreasing the dynamic power consumption caused by the charging and discharging of capacitive loads within that circuit. The multiplexor control signal may then switch the multiplexor circuit, selecting the unskewed second clock signal input based on the state of the multiplexor control signal (element 630). When this happens, the multiplexor circuit may ignore any output signals from the delay circuit and couple the unskewed clock signal to the clock splitting circuit (element 635). The clock splitting circuit will then produce a third clock signal and a fourth clock signal, based on the unskewed clock signal (element 640).

### CYCLE STEALING MODE

When the system is in the cycle stealing mode, the delay enable signal will turn on the delay circuit (element 645). Once enabled, the delay circuit may then receive the second clock signal, add a delay time, and create a delayed clock signal (element 650). The amount of delay time may be based on the configuration or design of the delay circuit and system timing needs. After the delay circuit adds a delay time to the second clock signal, the delayed clock signal is then transmitted to a delayed clock input of the multiplexor circuit (element 655).

Upon receiving the delayed clock signal at the multiplexor, the multiplexor control signal will switch the multiplexor circuit, selecting the delayed clock signal input (element 670). After selecting the delayed clock signal, the multiplexor then couples the delayed or skewed clock signal to the clock splitting circuit (element 675). The clock splitting circuit will in turn produce a third clock signal and a fourth clock signal, based on the delayed clock signal (element 680).

Regardless of whether the cycle stealing clock splitter is in the normal mode or the cycle stealing mode, the third clock signal and the fourth clock signal are adjusted for desired timing separation in a clock splitter spatial adjustment stage (element 685). The spatially adjusted clock signals, which may be referred to as a fifth clock signal and a sixth clock signal, are transmitted from the clock splitter system through a clock splitter output stage (element 690). The output stage may be necessary to drive a relatively large number of latching circuits.

Similar to the alternative embodiments shown in FIG. 1, FIG. 2, and FIGS. 4a-c, alternative embodiments may be derived from the technique employed in FIG. 6. One alternative embodiment to the technique shown in FIG. 6 may not employ a multiplexor for selecting an unskewed clock signal or selecting a delayed clock signal. One example of this embodiment may be similar to the alternative embodiments discussed for the cycle stealing circuit 431 of FIG. 4a. More particularly, the technique disclosed in FIG. 6 may employ both delay and multiplexor circuits similar to FIG. 4c or the embodiment may exclude the multiplexor and provide a fixed delay, similar to delay circuit 432 depicted in FIG. 4b. In a further alternative embodiment, a multiplexor may select from a number of different delay circuits.

It will be apparent to those skilled in the art having the benefit of this disclosure that the present invention contemplates arrangements and methods for power efficient cycle stealing in integrated circuits. It is understood that the form of the invention shown and described in the detailed description and the drawings are to be taken merely as examples. It is intended that the following claims be interpreted broadly to embrace all the variations of the example embodiments disclosed.

What is claimed is:

1. A circuit comprising:
a delay circuit to add a delay to a first clock signal, to produce a delayed clock signal, the delay circuit being adapted to receive a delay enable signal to enable and disable the delay circuit;
a multiplexing circuit coupled with the delay circuit to select between the first clock signal and the delayed clock signal based upon receipt of a multiplexor control signal, wherein selection of the delayed clock signal delays latching of an output for a first logic path to an input of a second logic path to increase a first quantity of time available for evaluation in the first logic path and to reduce a second quantity of time available for evaluation in the second logic path.

2. The circuit of claim 1, further comprising a clock splitter coupled with the multiplexor to split the delayed clock signal into more than one phases to coordinate the latching.

3. The circuit of claim 1, wherein the delay circuit is adapted to receive the delay enable signal to add the delay when the multiplexing circuit selects the delayed clock signal based upon the multiplexor control signal.

4. The circuit of claim 1, wherein the delay circuit comprises a first stage, the first stage comprising a pair of transistors to disable an output of the first stage in response to the delay enable signal.

5. The circuit of claim 1, wherein the delay circuit is disabled in response to the delay enable signal when the multiplexing circuit selects the first clock signal based upon the multiplexor control signal.

6. The circuit of claim 2, wherein the multiplexing circuit is adapted to select between more than one delay clock signals based upon the multiplexor control signal.

7. The circuit of claim 3, wherein the delay circuit comprises a second stage, wherein an input of the second stage is coupled with a pull-up transistor to pull up the input of the second stage while the output of the first stage is disabled.

8. A method for selecting between a first clock signal and a delayed clock signal, the method comprising:
delaying with a delay circuit the first clock signal to produce a delayed clock signal in response to receipt of a delay enable signal;
receiving at a multiplexing circuit the first clock signal, a multiplexor enable signal, and the delayed clock signal;
selecting by the multiplexing circuit between the first clock signal and the delayed clock signal based the multiplexor enable signal, wherein selecting the delayed clock signal delays latching of an output for a first logic path to an input of a second logic path, increasing a first quantity of time available for evaluation in the first logic path and reducing a second quantity of time available for evaluation in the second logic path.

9. The method of claim 8, further comprising disabling the delay circuit in response to the delay enable signal to reduce power consumption by the delay circuit.

10. The method of claim 8, further comprising disabling the delay circuit in response to the delay enable signal when the multiplexing circuit selects the normal clock signal based upon the multiplexor enable signal.

11. The method of claim 9, further comprising increasing an input voltage for the second stage to prevent current leakage due to tri-stating while the output of the first stage is disabled.

12. The method of claim 9, further comprising latching the output for the first logic path to the input of the second logic path via a clock splitter.

13. The method of claim 9, wherein delaying comprises turning on transistors at an output of a first stage of the delay circuit.

14. The method of claim 8, wherein delaying comprises turning on a first transistor in response to a delay enable signal to pull up an output of a stage of the delay circuit when the normal clock signal transitions to a low voltage and turning on a second transistor to pull down the output of the stage of the delay circuit when the normal clock signal transitions to a high voltage.

15. The method of claim 8, wherein delaying comprises producing more than one delayed clock signals, wherein the delayed clock signals are associated with different delays.

16. An apparatus comprising:
an input circuit to generate a gated clock signal based upon a normal clock signal;
a delay circuit coupled with the input circuit to add a time delay to the gated clock signal; and
a clock splitting stage coupled with the delay circuit to generate a first clock signal and a second clock signal based upon the clock signal and the time delay.

17. The apparatus of claim 16, further comprising a multiplexing circuit coupled between the delay circuit and the clock splitting stage to select between the gated clock signal and the delayed clock signal, wherein the clock splitting stage is adapted to generate the first clock signal and the second clock signal based upon the signal output by the multiplexing circuit.

18. The apparatus of claim 17, wherein the multiplexing circuit is adapted to select between more than one delayed clock signals based upon a multiplexor control signal.

19. The apparatus of claim 16, further comprising a clock output stage circuit coupled with the clock splitting stage to transmit the first clock signal to a first latch circuit and the second clock signal to a second latch circuit.

20. The apparatus of claim 16, wherein the delay circuit comprises a first delay circuit connected to a first output of the clock splitting stage to generate the first clock signal and a second delay circuit connected to a second output of the clock splitting stage to generate the second clock signal.
